(19) United States
(12) Patent Application Publication
(10) Pub. No.: US 2006/0150506 A1
(43) Pub. Date: Jul. 13, 2006

(54) Water self-refilling plant pot

(76) Inventor: Jieng-Chao Lee, Kaohsiung County (TW)

Correspondence Address: BACON & THOMAS, PLLC, 625 SLATERS LANE, FOURTH FLOOR, ALEXANDRIA, VA, 22314, US

(21) Appl. No.: 11/029,391

(22) Filed: Jan. 6, 2005

(51) Int. Cl. A01G 9/02

(52) U.S. Cl. 47/79

(57) ABSTRACT

A long-term water self-refilling plant pot is comprised of a hollow pot body, which includes a water-supplying section recessed from a top side of the pot body for accommodating a plant, a reservoir formed at the hollow space of the pot body for accommodating water, an infusion opening located on the pot body and running through the pot body for communication between the reservoir and outside, an infusion plug provided for sealing the infusion opening, at least one outfall running through an internal sidewall of the pot body for communication between the water-supplying section and the reservoir and having a diameter sufficiently large for preventing the liquid surface tension of water from sealing the outfall, and a regulating unit provided for controlling of sealing/unsealing the outfall. Thus, the plant pot can keep supplying the plant with adequate water without manual watering for a period of time.

### BACKGROUND OF THE INVENTION

1. Field of the Invention

The present invention relates generally to plant pots, and more particularly to a long-term water self-refilling plant pot.

2. Description of the Related Art

For facilitating promotion of plant pots, an unmanned self-watering pot device has been being developed for recent years, being characterized by that the self-watering device is comprised of a table having a channel and a slot in communication with the channel, a pot having soil and a plant raised in the soil, a refill bottle having a cap and receiving water for fully pouring into the channel of the table, and a capillary wick having two ends respectively inserted into the soil of the pot and placed in the channel, such that the water in the refill bottle can flow into the channel and the slot. While the water level of the channel reaches a distal end of the cap of the refill bottle, the water in the refill bottle stops flowing into the channel and the slot and the capillary wick sucks and transports the water to the pot. While the water level of the channel lowers to be lower than the distal end of the cap, the water of the refill bottle keeps flowing into the channel and the slot to supply the plant with the water.

However, such unmanned self-watering pot device includes numerous components and needs complicated production process to be structurally complex, thereby failing to effectively reduce the production cost. In addition, the device is very inconvenient for operation and maintenance.

### SUMMARY OF THE INVENTION

The primary objective of the present invention is to provide a long-term water self-refilling plant pot, which keeps supplying the plant raised therein with adequate water for a period of time without manual watering.

The secondary objective of the present invention is to provide a long-term water self-refilling plant pot, which is structurally simple and easy for production.

The foregoing objectives of the present invention are attained by the long-term water self-refilling plant pot, which is comprised of a hollow pot body having a water-supplying section, a reservoir, an infusion opening, an infusion plug, at least one outfall, and a regulating unit. The water-supplying section is recessed from a top side of the pot body for accommodating a plant. The reservoir is formed at the hollow space of the pot body for accommodating water. The infusion opening is located on the pot body, running through the pot body for communication between the reservoir and outside. The infusion plug is provided for sealing the infusion opening. The outfall runs through an internal sidewall of the pot body for communication between the water-supplying section and the reservoir and has a diameter, which is large enough to prevent the liquid surface tension of water from sealing the outfall. The regulating unit is provided for controlling of sealing/unsealing the outfall.

### BRIEF DESCRIPTION OF THE DRAWINGS

FIG. 1 is a schematic sectional view of a first preferred embodiment of the present invention.

FIG. 2 is similar to FIG. 1, but showing an upside-down view of the present invention for infusing water.

FIG. 3 is an enlarged view taken from a circle A indicated in FIG. 1.

FIG. 4 is similar to FIG. 3, showing that the water is being supplied from the reservoir into the water-supplying section.

FIG. 5 is a top view of a second preferred embodiment of the present invention.

FIG. 6 is a sectional view of a third preferred embodiment of the present invention, showing that the regulating unit stops the water from flowing from the reservoir into the water-supplying section.

FIG. 7 is similar to FIG. 6, showing that the regulating unit allows the water to flow from the reservoir through one of the outfalls into the water-supplying section.

FIG. 8 is similar to FIG. 6, showing that the regulating unit allows the water to flow from the reservoir through the other outfall into the water-supplying section.

FIG. 9 is a sectional view of a fourth preferred embodiment of the present invention without water inside.

FIG. 10 is another sectional view of the fourth preferred embodiment of the present invention with water inside.

FIG. 11 is a sectional upside-down view of a fifth preferred embodiment of the present invention for infusing water.

FIG. 12 is a sectional view of the fifth preferred embodiment of the present invention.

### DETAILED DESCRIPTION OF PREFERRED EMBODIMENTS

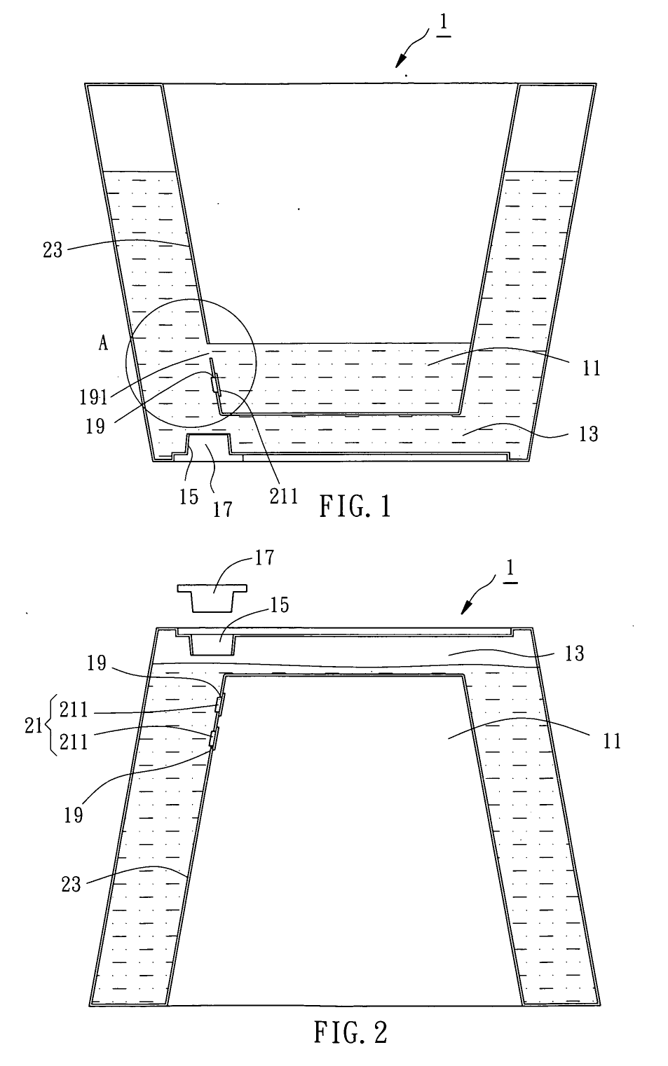

Referring to FIGS. 1-2, a long-term water self-refilling plant pot 1 constructed according to a first preferred embodiment of the present invention is a hollow pot body and comprised of a water-supplying section 11, a reservoir 13, an infusion opening 15, an infusion plug 17, two outfalls 19, and a regulating unit 21.

The water-supplying section 11 is recessed downwards from a top side of the pot body for accommodating a plant. The reservoir 13 is the hollow space of the pot body for accommodating water. The infusion opening 15 is located at a bottom side of the pot body, running through the same for communication between the reservoir 13 and outside and for infusing water therefrom by the user. The infusion plug 17 is mounted in the infusion opening 15 for sealing the infusion opening 15 to avoid the water from leakage after the user infuses the water through the infusion opening 15 into the water-supplying section 11 of the pot body. The two outfalls 19, which are respectively an upper outfall and an lower outfall located below the upper outfall, are located at different elevation of an internal lateral sidewall 23 of the pot body, running through the internal lateral sidewall 23 and each having a 1 cm diameter, by which the outfall can prevent the liquid surface tension of the water from sealing itself, for communication between the water-supplying section 11 and the reservoir 13. The regulating unit 21 is embodied as two drain plugs 211 respectively for sealing the two outfalls 19 to prevent the water from leakage after the user infuses the water into the pot body. Each of the outfalls 19 is defined as an outlet 191 while the drain plug 211 is unplugged from the outfall 19.

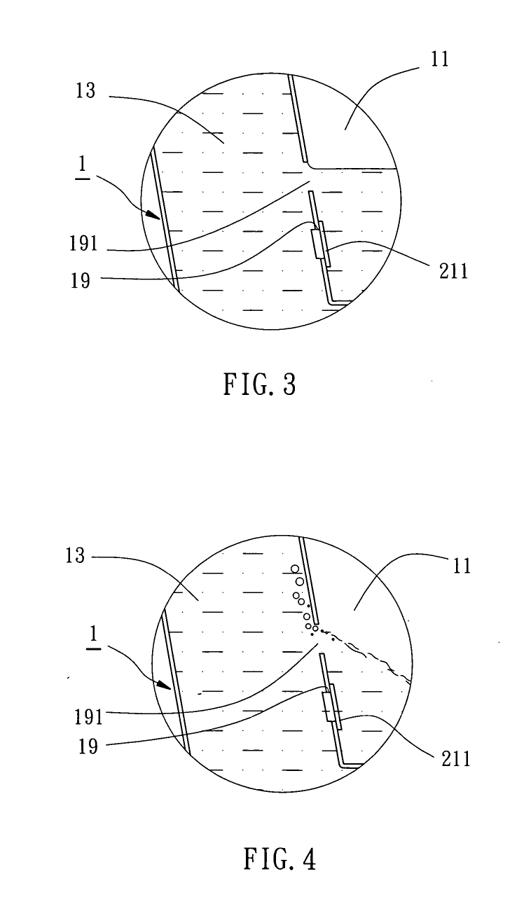

In operation, as shown in FIG. 2, put the pot body upside-down, unplug the infusion plug 17 from infusion opening 15, and then infuse the water into the infusion opening 15. After the water infusion is completed, reposition the infusion plug 17 to seal the infusion opening 15. Reset the pot body in normal position and then unplug one of the drain plugs 211 based on the requirement of the plant for water to force the water by the air pressure to flow from the reservoir 13 into the water-supplying section 11. As shown in FIG. 4, while the water level of the water-supplying section 11 gradually rises up to a lower part of the outlet 191, the other part of the outlet 191 can be sealed by the surface tension of the water to cause the balance of pressure at two ends of the outlet 191; in other words, the air pressure and water gravity of the reservoir 13 above the outlet 191 are in balance with the air pressure and water surface tension of the water-supplying section 11; such that the water no longer flows into the outlet 191, as shown in FIG. 3. While the water level of the water-supplying section 11 drops a little to enable the other part of the outlet 191 not to be sealed by the water surface tension, the water of the reservoir 13 can again flow through the outlet 191 into the water-supplying section 11 for refill. Before the water of the reservoir 13 above the outlet 191 runs out, the water level of the water-supplying section 11 keeps abutting a top end of the outlet 191, as shown in FIG. 1.

As a whole, the primary feature of the first preferred embodiment of the present invention is to employ the air pressure and the liquid surface tension to enable the elevation where the outfalls 19 are located to control the water level of the water-supplying section 11, thereby resulting in simple structure and easy production of the whole plant pot 1.

It is to be noted that there can be more than two of the outfalls 19 together with the drain plugs 211, which correspond to the outfall 19 in number, in the first preferred embodiment to meet different requirement of different plants for water and one of the drain plugs 211 is optionally unplugged once in operation to meet different requirement of different plants for the water level.

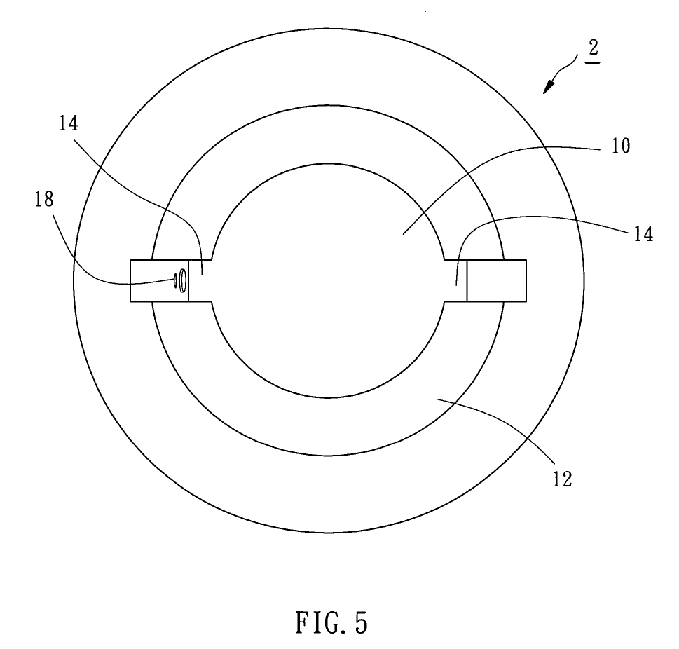

Referring to FIG. 5, the long-term water self-refilling plant pot 2 constructed according to a second preferred embodiment of the present invention is similar to the first preferred embodiment, but having difference as follows. The plant pot 2 further includes at least one recession 14 (two recessions facing to each other in this embodiment), on which sidewall the outfall 18 is located, to define a buffer against the plant for preventing the outfall 18 from obstruction incurred by that the plant is too close to the outfall 18.

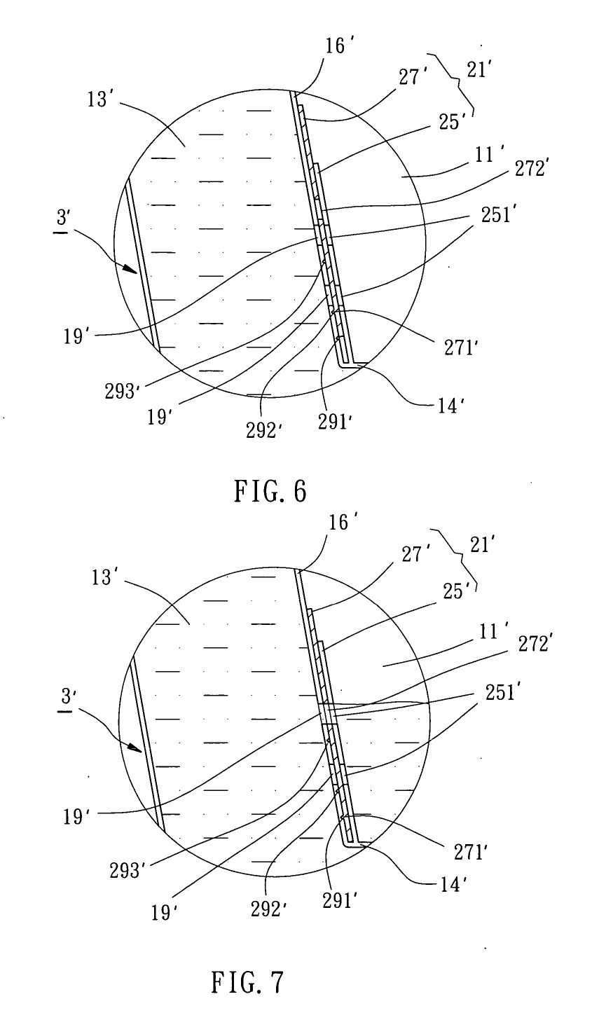

The regulating unit 21 can be alternatively a gate-like member. Referring to FIGS. 6-8, the long-term water self-refilling plant pot 3 constructed according to a third preferred embodiment of the present invention is similar to the first preferred embodiment and comprised of a water-supplying section 11′, a reservoir 13′, two outfalls 19′, and a regulating unit 21′, but having difference as recited below. The two outfalls 19′ are the same in diameter. The regulating unit 21′ includes a drain gate 25′, an intermediate gate 27′, and three locating ditches, which are respectively a first locating ditch 291′, a second locating ditch 292′, and a third locating ditch 293′. The drain gate 25′ is located at an edge of an internal bottom side of the pot body, abutting the two outfalls 19′ and being spaced from the internal lateral sidewall 16′ of the pot body. The drain gate 25′ has its width as twice as the diameter of either of the outfalls 19′, having two through holes 251′, which are respectively an upper through hole and a lower through hole and correspond respectively to the two outfalls 19′. The intermediate gate 27′ is fitted between the drain gate 25′ and the internal lateral sidewall 16′, having a convex portion 271′ protruding from a lower side thereof and abutting the internal lateral sidewall 16′, and a through hole 272′ running through the internal lateral sidewall 16′ and located above the convex portion 271′. The three locating ditches 291′, 292′, and 293+ are arranged one by one in elevation and located on the internal lateral sidewall 16′ abutting the two outfalls 19′, each for engaging the convex portion 271′. While the convex portion 271′ engages the first locating ditch 291′, the through hole 272′ of the intermediate gate 27′ communicates respectively with the upper outfall 19′ and the upper through hole 251′. While the convex portion 271′ engages the third locating ditch 293′, the through hole 272′ communicates respectively with the lower outfall 19′ and the lower through hole 251′.

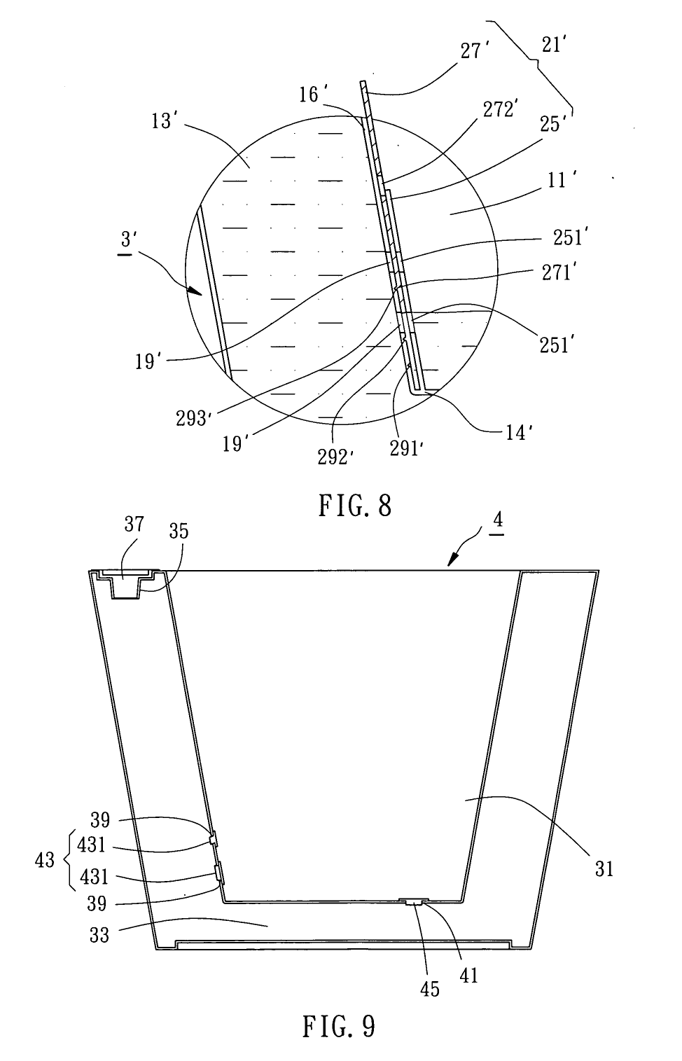

The operational difference of the third preferred embodiment of the present invention from the first embodiment is recited below. While intending to fill the plant pot 3 with water, the user can let the convex portion 271′ engage the second locating ditch 292′ to disable the communication between the two outfalls 19′ and the two through holes 251′ and to prevent the water in the reservoir 13′ from leakage by the regulating unit 21′, as shown in FIG. 6. While intending to keep the water level of the water-supplying section 11′ at the upper outfall 19′, let the convex portion 271′ engage the first locating ditch 291′ to enable the through hole 272′ to communicate with the upper outfall 19′ and the upper through hole 251′, such that the water flows from the reservoir 13′ into the water-supplying section 11′ and the water level of the water-supplying section 11′ keeps abutting the top end of the upper outfalls 19′, as shown in FIG. 7. While intending to keep the water level of the water-supplying section 11′ at the lower outfall 19′, let the convex portion 271′ engage the third locating ditch 293′ to enable the through hole 272′ to be in communication with the lower outfall 19′ and the lower through hole 251′ and keep the water level of the water-supplying section 11′ abutting the top end of the lower outfall 19′, as shown in FIG. 8.

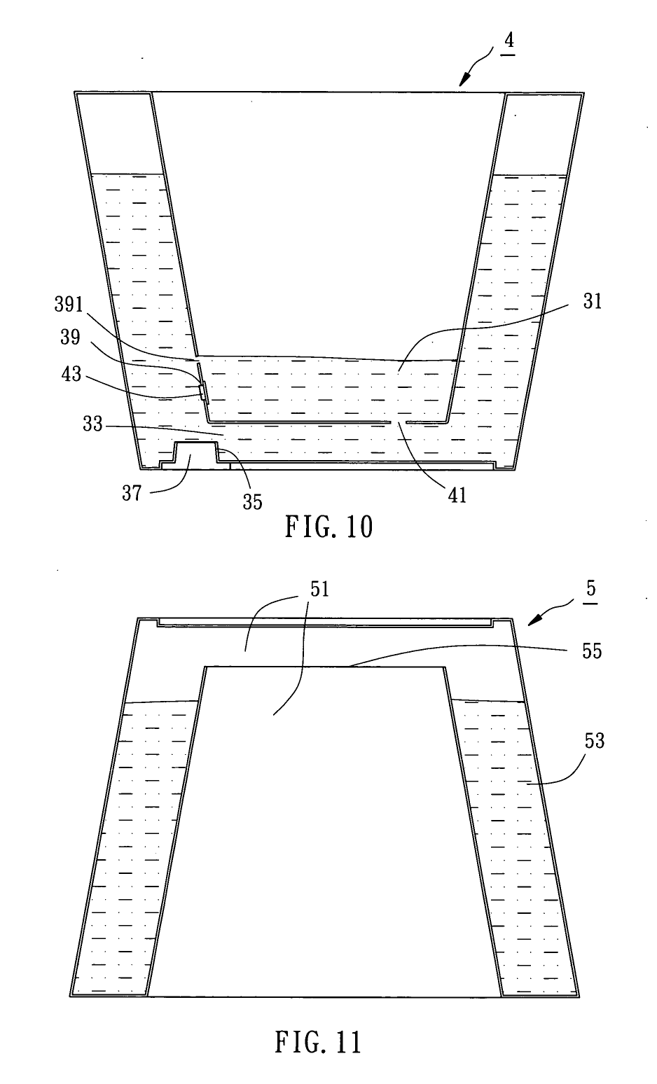

Referring to FIGS. 9-10, the long-term water self-refilling plant pot 4 constructed according to a fourth preferred embodiment of the present invention is similar to the first preferred embodiment, but having difference below. The plant pot 4 is comprised of a water-supplying section 31, a reservoir 33, an infusion opening 35, an infusion plug 37, two lateral outfalls 39, a bottom outfall 41, and a regulating unit 43. The infusion opening 35 is located on a top side of the pot body. The two lateral outfalls 39 are identical to the outfalls of the first preferred embodiment in location, but each having the diameter of any size. The bottom outfall 41 runs through the internal bottom sidewall of the pot body for ensuring the water to flow into the water-supplying section 31 from the bottom side of the water-supplying section 31. The regulating unit 43 includes two lateral drain plugs 431 and a bottom drain plug 45 respectively for sealing the lateral and bottom outfalls 39 and 41 to prevent the water from leakage from the lateral and bottom outfalls 39 and 41 while the user fills the pot body with the water.

It is to be noted that there can be alternatively more than two lateral outfalls 39, to which the lateral drain plugs 431 correspond in number and are unplugged by one once in operation, according to the requirement of different plants for water. If the plant is relatively larger in size, there can be alternatively more than one bottom outfall 41, to which the bottom drain plug 431 corresponds in number and is unplugged by one once in operation, according to the requirement of different plants for water. The regulating unit 431 can alternatively be a gate-like member in addition to the drain plugs 431 for regulating the water level of the water-supplying section 31.

After infusing the water into the plant pot 4, unplug one lateral drain plug 431 according to different requirement of the plant for the water and unplug the bottom drain plug 45; meanwhile, the water of the reservoir 33 is forced by the air pressure to flow from the bottom outfall 41 into the water-supplying section 31; meanwhile, the lateral outlet 391, which is defined by the lateral outfall 39 that the lateral drain plug 431 is unplugged, is too small in diameter to let the water pass therethrough because of the liquid surface tension at the outlet 391. While the water level of the water-supplying section 31 drops a little to expose a part of the outlet 391, the water of the reservoir 33 flows through the bottom outfall 41 into the water-supplying section 31 for refill. Before the water of the reservoir 33 above the lateral outlet 391 runs out, the water level of the water-supplying section 31 keeps abutting the top end of the lateral outlet 391, as shown in FIG. 10.

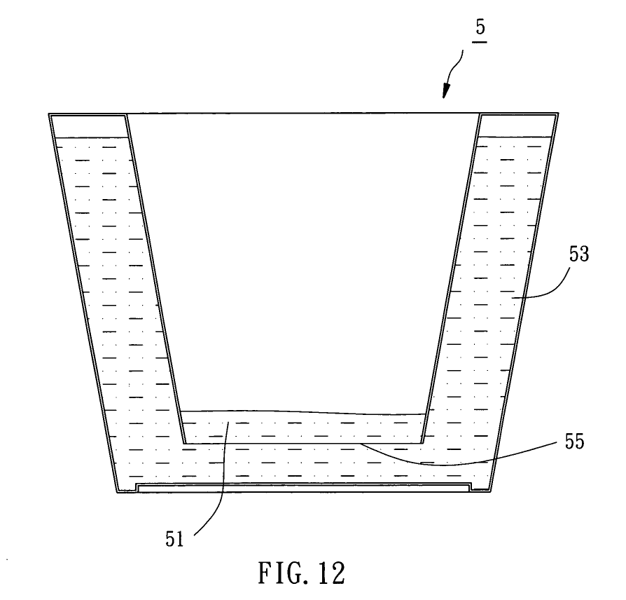

Referring to FIGS. 11-12, the long-term water self-refilling plant pot 5 constructed according to a fifth preferred embodiment of the present invention is a hollow pot body, comprised of a water-supplying section 51, a reservoir 53, and an infusion opening 55. The water-supplying section 51 is recessed from a top side of the pot body for accommodating a plant. The reservoir 53 is the hollow space of the pot body and located between a peripheral sidewall of the water-supplying section 51 and an external sidewall of the pot body for accommodating water. The infusion opening 55 is located at a bottom side of the water-supplying section 51 for communication between the water-supplying section 51 and the reservoir 53.

In operation, put the plant pot 5 upside-down, infuse the water through the infusion opening 55 into the reservoir 53, as shown in FIG. 11, and then set the plant pot 5 in normal position quickly. In the meantime, the gravity forces the water of the reservoir 53 to flow toward the water-supplying section 51 to enable the water level of the water-supplying section 51 to reach a specific elevation to overflow the infusion opening 55 and then stop rising until the air pressure over the water level of the water-supplying section 51 is in balance with the gravity and the air pressure over the water level of the reservoir 53. While the water level of the water-supplying section 51 drops a little, the water of the reservoir 53 immediately flows through the infusion opening 55 into the water-supplying section 51 for refill. The water level of the water-supplying section 51 keeps at the specific elevation, as shown in FIG. 12, as long as the water level of the reservoir 53 is higher than that of water-supplying section 51.

What is claimed is:

1. A long-term water self-refilling plant pot having a hollow pot body, comprising:
a water-supplying section recessed from a top side of said pot body for accommodating a plant;
a reservoir formed at the hollow space of said pot body for accommodating water;
an infusion opening running through said pot body for communication between said reservoir and outside;
an infusion plug for sealing said infusion opening;
an outfall running through a lateral sidewall of said pot body abutting said water-supplying section for communication between said water-supplying section and said reservoir, said outfall having a diameter sufficiently large for preventing liquid surface tension from sealing itself; and
a regulating unit for control of sealing/unsealing said outfall.

2. The plant pot as defined in claim 1, wherein said regulating unit comprises at least one drain plug corresponding to said outfall in number for sealing said outfall.

3. The plant pot as defined in claim 1, wherein said regulating unit comprises a drain gate, an intermediate gate, and a locating ditch, which is larger than said outfall by one in number, said drain gate extending from a bottom sidewall of said pot body and abutting said outfall and spaced from said lateral sidewall of said pot body for fully sealing said outfall, said drain gate having at least one through hole respectively corresponding to said outfall and having a diameter sufficiently large for preventing liquid surface tension from sealing said through hole, said intermediate gate being fitted between said drain gate and said lateral side wall of said pot body, said intermediate gate having a convex portion located at its lower side and abutting said lateral sidewall and a through hole formed at its upper side, said locating ditches being formed on said lateral sidewall abutting said outfall in elevation for engaging said convex portion, whereby said intermediate gate blocks the communication between said through hole of said drain gate and said outfall while said convex portion engages one of said locating ditches, and said intermediate gate enables the communication between said through hole of said drain gate and said outfall while said convex portion engages any of the other said locating ditches.

4. The plant pot as defined in claim 1 further comprising a recession recessed from said lateral sidewall abutting said water-supplying section; said outfall is located at said recession.

5. A long-term water self-refilling plant pot having a hollow pot body, comprising:
a water-supplying section recessed from a top side of said pot body for accommodating a plant;
a reservoir formed at the hollow space of said pot body for accommodating water;
an infusion opening running through said pot body for communication between said reservoir and outside;
an infusion plug for sealing said infusion opening;
a lateral outfall running through a lateral sidewall of said pot body abutting said water-supplying section for communication between said water-supplying section and said reservoir;
a regulating unit for control of sealing/unsealing said outfall; and
a bottom outfall running through a bottom sidewall of said pot body abutting said water-supplying section for communication between said water-supplying section and said reservoir.

6. The plant pot as defined in claim 5, wherein said regulating unit comprises a drain plug corresponding to said outfall in number for sealing said outfall.

7. The plant pot as defined in claim 5, wherein said regulating unit comprises a drain gate, an intermediate gate, and a locating ditch, which is larger than said outfall by one in number, said drain gate extending from a bottom sidewall of said pot body and abutting said outfall and spaced from said lateral sidewall of said pot body for fully sealing said outfall, said drain gate having a through hole respectively corresponding to said outfall in number and preventing liquid surface tension from sealing said through hole, said intermediate gate being fitted between said drain gate and said lateral side wall of said pot body, said intermediate gate having a convex portion located at its lower side and abutting said lateral sidewall and a through hole formed at its upper side, said locating ditches being formed on said lateral sidewall abutting said outfall in elevation for engaging said convex portion, whereby said intermediate gate blocks the communication between said through hole of said drain gate and said outfall while said convex portion engages one of said locating ditches, and said intermediate gate enable the communication between said through hole of said drain gate and said outfall while said convex portion engages any of the other said locating ditches.

8. The plant pot as defined in claim 5 further comprising a recession recessed from said lateral sidewall abutting said water-supplying section; said outfall is located at said recession.

9. A long-term water self-refilling plant pot having a hollow pot body, comprising:
a water-supplying section recessed from a top side of said pot body for accommodating a plant;
a reservoir formed at the hollow space of said pot body and located between the top side, a bottom side, two external sidewalls, and two internal sidewalls of said pot body for accommodating water; and
an infusion opening formed at a bottom side of said water-supplying section and abutting the bottom side of said pot body for communication between said water-supplying section and said reservoir.
